(19) United States
(12) Patent Application Publication
(10) Pub. No.: US 2026/0004345 A1
(43) Pub. Date: Jan. 1, 2026

(54) TRANSFER OF AN OFFCHAIN ASSET BASED ON SATISFACTION OF TRANSFER CONDITIONS FOR AN ONCHAIN ASSET

(71) Applicant: Unstoppable Domains, Inc., Las Vegas, NV (US)

(72) Inventor: Lisa Seacat DeLuca, Bozeman, MT (US)

(21) Appl. No.: 18/754,650

(22) Filed: Jun. 26, 2024

(51) Int. Cl. G06Q 40/04; G06Q 40/03

(52) U.S. Cl. CPC G06Q 40/04; G06Q 40/03; G06Q 2220/00

(57) ABSTRACT

According to a present invention embodiment, a system for transferring an offchain asset comprises one or more memories and at least one processor coupled to the one or more memories. The system receives a request to obtain the offchain asset for a user. A transaction is conducted for an onchain asset associated with the user and corresponding to the offchain asset. The system monitors for a set of conditions associated with the transaction for the onchain asset. The offchain asset is transferred to the user in response to occurrence of the set of conditions. Embodiments of the present invention further include a method and computer program product for transferring an offchain asset in substantially the same manner described above.

### TECHNICAL FIELD

Present invention embodiments relate to networking and, more specifically, to transfer of offchain assets (e.g., Web2 domains or domain names, ICANN domains or domain names, Domain Name System (DNS) domains or domain names, other centralized domain systems, etc.) based on satisfaction of transfer conditions for an onchain asset (e.g., a non-fungible token (NFT), a blockchain domain or domain name, etc.).

### BACKGROUND

### Discussion of the Related Art

Web2 generally refers to a version of the web (or Internet) that utilizes a centralized Domain Name System (DNS) to translate domain names into corresponding Internet Protocol (IP) addresses in order to access a web site. Domain Name System (DNS) creates a set of one or more records when a domain name is registered. DNS records (or text files) reside in DNS servers and provide information pertaining to a domain name including an associated IP address and request handling.

In contrast, Web3 generally refers to a decentralized version of the web (or Internet) based on blockchains and peer-to-peer networks. Non-fungible token (NFT) marketplaces have begun to allow support for the ability to take a loan for payment for an NFT. Further, users may borrow funds against their NFTs based on amounts and interest rates offered by lenders. In other words, a blockchain-based non-fungible token (NFT) loan system enables borrowing and lending using NFTs as collateral.

Users may desire to obtain an offchain asset (e.g., Web2 domains or domain names, ICANN domains or domain names, Domain Name System (DNS) domains or domain names, etc.) corresponding to an onchain asset they currently own (e.g., Web3 domains or domain names, blockchain domains or domain names, etc.). However, options for acquiring the corresponding offchain asset may be limited relative to the onchain asset.

### SUMMARY

According to one embodiment of the present invention, a system for transferring an offchain asset comprises one or more memories and at least one processor coupled to the one or more memories. The system receives a request to obtain the offchain asset for a user. A transaction is conducted for an onchain asset associated with the user and corresponding to the offchain asset. The system monitors for a set of conditions associated with the transaction for the onchain asset. The offchain asset is transferred to the user in response to occurrence of the set of conditions. Embodiments of the present invention further include a method and computer program product (e.g., including one or more computer readable media with instructions executable by one or more processors) for transferring an offchain asset in substantially the same manner described above.

### BRIEF DESCRIPTION OF THE DRAWINGS

Generally, like reference numerals in the various figures are utilized to designate like components.

FIG. 1 is a diagrammatic illustration of an example computing environment according to an embodiment of the present invention.

FIG. 2 is a block diagram of an example computing device according to an embodiment of the present invention.

FIG. 3 is a flowchart of a method of registering a name or other identifier for an onchain asset (e.g., Web3, blockchain, etc.) based on a name or other identifier for an offchain asset (e.g., Web2, Domain Name System (DNS), etc.) according to an embodiment of the present invention.

FIG. 4 is a flowchart of a method of transferring an offchain asset based on satisfying transfer conditions for an onchain asset according to an embodiment of the present invention.

FIG. 5 is a schematic illustration of an example graphical user interface providing registered blockchain domain names of a user with corresponding loan information according to an embodiment of the present invention.

### DETAILED DESCRIPTION

Web2 generally refers to a version of the web (or Internet) that utilizes a centralized Domain Name System (DNS) to translate domain names into corresponding Internet Protocol (IP) addresses in order to access a web site. Domain Name System (DNS) creates a set of one or more records when a domain name is registered. DNS records (or text files) reside in DNS servers and provide information pertaining to a domain name including an associated IP address and request handling.

In contrast, Web3 generally refers to a decentralized version of the web (or Internet) based on blockchains and peer-to-peer networks. Non-fungible token (NFT) marketplaces have begun to allow support for the ability to take a loan for payment for an NFT. Further, users may borrow funds against their NFTs based on amounts and interest rates offered by lenders.

A blockchain-based non-fungible token (NFT) loan system enables borrowing and lending using NFTs as collateral. The NFT loan system enables NFT owners (or borrowers) to access capital without selling their prized possessions (e.g., NFTs, etc.), while lenders may earn interest on their crypto holdings. Further, smart contracts ensure secure transactions and immutable recording of loan agreements on a blockchain. When a loan is late or in default, a lender may simply execute a smart contract call to take possession of the NFT or other digital asset.

For example, a borrower may be a non-fungible token (NFT) owner seeking liquidity without selling their assets (e.g., NFTs, blockchain domains or domain names, etc.). The borrower may deposit their NFT as collateral from their blockchain wallet account into a secure escrow (e.g., a blockchain wallet account, etc.) managed by a smart contract on a blockchain. The transfer may be accomplished by conducting a transaction to place a record on the blockchain indicating transfer of the NFT from the borrower wallet account to the secure escrow.

The loan amount is determined by the value of the non-fungible token (NFT), typically expressed as a percentage (e.g., Loan-to-Value ratio (LTV)). Platforms typically set an LTV limit to mitigate risks for lenders. A higher LTV ratio indicates a larger loan amount compared to the NFT's value, but also carries a greater risk of default. A platform may include a secure platform that facilitates loan applications, smart contract execution, and escrow services. The smart contract indicates terms of the loan agreement, including interest rate, repayment period, and potential penalties for late payments.

Lenders may be investors looking to earn passive income on their cryptocurrency holdings. The lenders may browse available non-fungible tokens (NFTs) and choose to fund loans based on the NET's value, potential returns, and the lender risk tolerance. Upon successful funding, the borrower receives the loan amount in cryptocurrency or fiat currency (e.g., cash, etc.) (depending on the platform).

Borrowers must repay the loan with interest within the agreed timeframe. If the value of the non-fungible token (NFT) falls below a pre-determined threshold (liquidation ratio), the smart contract may automatically sell the NFT to recover the loan amount, or require a larger deposit to keep the loan valid.

Once the loan is fully repaid, the smart contract automatically releases the non-fungible token (NFT) from the secure escrow back to the borrower. The transfer may be accomplished by conducting another transaction to place a record on the blockchain indicating transfer of the NFT from the secure escrow to the borrower wallet account.

However, the non-fungible token (NFT) loan system presents some challenges. For example, determining a fair market value of unique NFTs can be subjective and complex. Further, fluctuations in a cryptocurrency market may lead to loan defaults when the NFT's value falls below a certain threshold. Moreover, a legal framework surrounding NFTs and DeFi (Decentralized Finance) is still evolving.

In addition, options for acquiring an offchain asset (e.g., Web2 domain or domain name, ICANN domain or domain name, Domain Name System (DNS) domain or domain name, etc.) may be limited relative to an onchain asset (e.g., Web3 domain or domain name, blockchain domain or domain name, etc.).

Accordingly, an embodiment of the present invention enables an onchain asset (e.g., Web3 domain or domain name, blockchain domain or domain name, non-fungible token (NFT), etc.) to have a unique relationship with a corresponding offchain asset (e.g., Web2 domain or domain name, ICANN domain or domain name, Domain Name System (DNS) domain or domain name, etc.). This enables the present invention embodiment to improve fractional ownership and loans of onchain assets that are linked to offchain assets. In other words, an offchain asset may leverage options (e.g., conditions for transfer, such as loans, etc.) available for obtaining onchain assets in order to acquire offchain assets. For example, an offchain asset (e.g., Web2 domain or domain name, ICANN domain or domain name, Domain Name System (DNS) domain or domain name, etc.) may be obtained using a loan against a corresponding onchain asset (e.g., Web3 domain or domain name, blockchain domain or domain name, non-fungible token (NFT), etc.), thereby enabling loans to be used to acquire the offchain asset.

An embodiment of the present invention transfers an offchain asset (e.g., Web2 domain or domain name, ICANN domain or domain name, Domain Name System (DNS) domain or domain name, etc.) to a user upon a final payoff of a non-fungible token (NFT) loan for a corresponding onchain asset (or upon acquisition of all fractions of a fractionally owned NFT). For example, the present invention embodiment may update ownership records of a DNS domain name based on NFT related actions (e.g., payoff of loan, acquisition of fractional portions of the NFT, etc.). Transfer of an onchain or offchain asset may include any action or transaction that provides ownership, rights, registration, and/or any other interest in the onchain or offchain asset. Further, acquiring or obtaining an onchain or offchain asset may include obtaining ownership, rights, registration, and/or any other interest in the onchain or offchain asset.

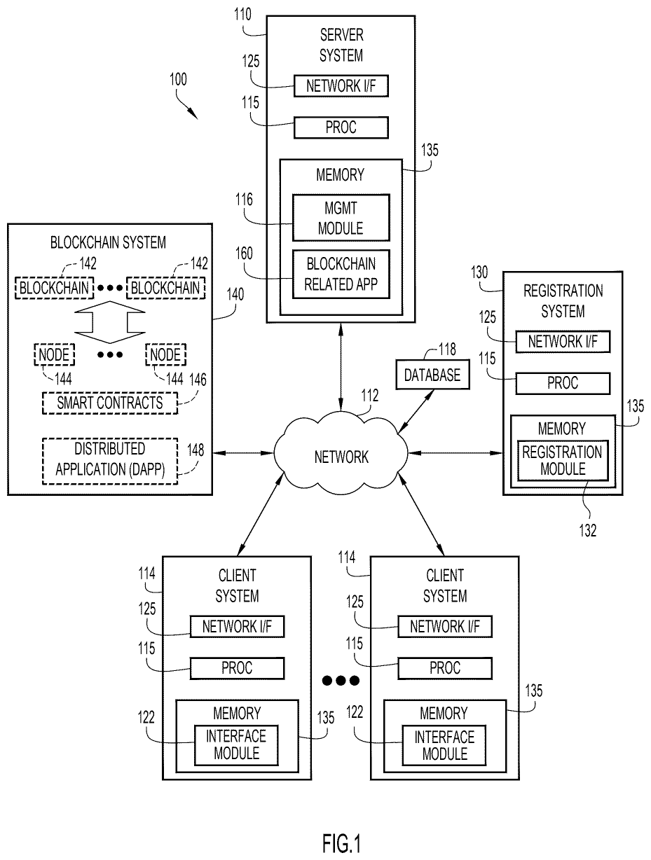

An example environment 100 for use with present invention embodiments is illustrated in FIG. 1. Specifically, environment 100 includes one or more server systems 110, one or more client or end-user systems 114, one or more registration systems 130, and one or more blockchain systems 140 each implementing and maintaining at least one corresponding blockchain 142. Server systems 110, client systems 114, registration systems 130, and/or blockchain systems 140 may be remote from each other and communicate over a network 112. The network may be implemented by any number of suitable communications media (e.g., wide area network (WAN), local area network (LAN), Internet, Intranet, etc.). Alternatively, server systems 110, client systems 114, registration systems 130, and/or blockchain systems 140 may be local to each other, and communicate via any appropriate local communication medium (e.g., local area network (LAN), hardwire, wireless link, Intranet, etc.).

Server systems 110 include a management module 116. Management module 116 may interface with a user via client system 114, and/or may be of the form of an Application Programming Interface (API) to perform onchain and/or offchain asset management (e.g., for domains or other objects, etc.). The management module may include, or have access to, a blockchain-based non-fungible token (NFT) loan system as described above to provide borrowing and lending using NFTs as collateral. The management module may process requests from any entities (e.g., user, application, service, computing or other device, etc.).

Client systems 114 may include an interface module 122 to provide a graphical user (e.g., GUI, etc.) or other interface (e.g., command line prompts, menu screens, etc.) that enables users to access server systems 110 and blockchain systems 140 for managing onchain and/or offchain assets (e.g., domains or other objects, etc.). The interface module may include any conventional or other browser to access server systems 110 and blockchain systems 140.

Registration systems 130 include a registration module 132 that registers and manages names or other identifiers for offchain assets (e.g., Web2 domains or domain names, ICANN domains or domain names, Domain Name System (DNS) domains or domain names, etc.). By way of example, the registration system may include a conventional or other DNS server.

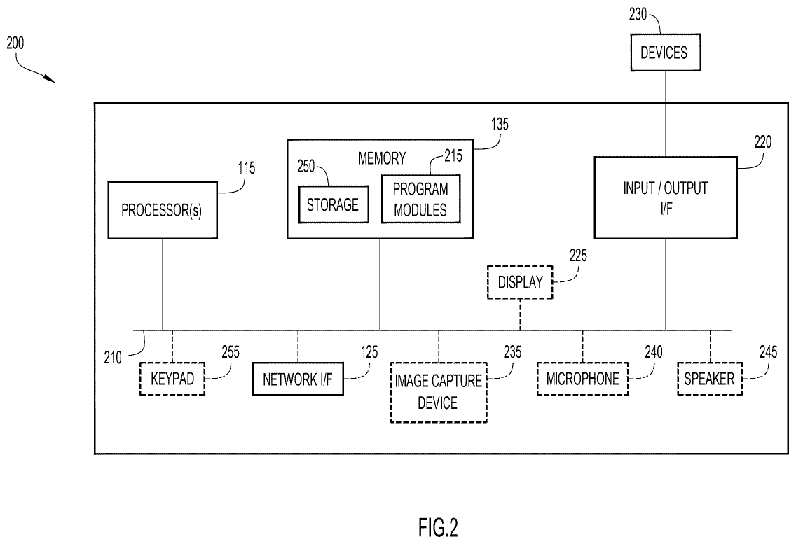

Blockchain systems 140 may each include one or more nodes 144 to implement and maintain at least one corresponding blockchain 142. The nodes may be implemented by any suitable computing devices (e.g., as described below for FIG. 2). The blockchain is generally in the form of a ledger that includes a series of records or blocks chained or linked together. The blockchain is typically managed by a peer-to-peer network (of nodes 144) and used as a distributed ledger. Nodes 144 of the peer-to-peer network communicate and verify new blocks according to a protocol. The peer-to-peer network provides a decentralized approach, where each node has a copy of a blockchain 142. Transactions are transmitted to the peer-to-peer network, where mining nodes (nodes 144) process the transactions. The mining nodes validate a transaction, insert the transaction into a current block, and transmit the block to the other nodes. Blockchain 142 may be implemented by any conventional or other blockchain, and may be a public (e.g., no access restrictions, etc.), private (e.g., restricted access, etc.), or hybrid (e.g., with centralized and decentralized features) blockchain.

Blockchain systems 140 may include one or more distributed or decentralized applications (dApps) 148 to perform various operations (e.g., financial or other transactions or operations related to a blockchain, etc.). In addition, a blockchain 142 may store software (e.g., typically referred to as smart contracts 146) that executes on the blockchain in response to occurrence of pre-defined conditions (e.g., loan payments, etc.). The smart contracts may monitor transactions and detect occurrence of transfer conditions (e.g., loan payoff, complete ownership of an onchain asset, etc.) for transferring onchain and/or offchain assets as described below. The onchain assets may be associated with the same and/or various different blockchains.

Interface module 122 of client systems 114 may further provide a graphical user (e.g., GUI, etc.) or other interface (e.g., command line prompts, menu screens, etc.) that enables users to access distributed applications (dApps) 148 and/or smart contracts 146 on blockchain systems 140 for performing various operations (e.g., financial or other transactions or operations related to a blockchain, loan transactions, etc.). The interface module may include any conventional or other browser to access the decentralized applications (dApps) of blockchain systems 140. The interface module may natively, or include extensions to, access the decentralized applications (dApps) and/or other components of blockchain system 140. The interface module may provide a user interface to serve as a front end for a decentralized application (dApp) 148, where back end processing for the decentralized application (dApp) is performed on a blockchain system 140. Client systems 114 may further provide reports or notifications pertaining to requests from users (e.g., results of a loan request or transaction, transfers of onchain and/or offchain assets, etc.).

Server systems 110 further include one or more blockchain related applications 160 for performing various operations (e.g., transactions or operations related to a blockchain, access asset information based on an associated asset, etc.). Management module 116 and blockchain related applications 160 may be on the same or different server systems 110. The blockchain related application may process requests from any entities (e.g., user, application, service, computing or other device, etc.).

A database or offchain storage system 118 may store various information for a blockchain asset and/or transfer conditions (e.g., blockchain asset information, mappings of blockchain assets to blockchains, blockchain domain content, loan or other transfer condition information, etc.). The database system may be implemented by any conventional or other database or offchain storage unit (e.g., Interplanetary File System (IPFS), etc.), may be local to or remote from server systems 110, client systems 114, registration systems 130, and/or blockchain systems 140, and may communicate via any appropriate communication medium (e.g., local area network (LAN), wide area network (WAN), Internet, hardwire, wireless link, Intranet, etc.).

Server systems 110, client systems 114, and registration systems 130 may be implemented by any conventional or other computer systems preferably equipped with a display or monitor, a base, optional input devices (e.g., a keyboard, mouse or other input device), and any software for use by present invention embodiments (e.g., server/communications software, blockchain software, management module 116, interface module 122, registration module 132, blockchain related applications 160, etc.). The base may include at least one hardware processor 115 (e.g., microprocessor, controller, central processing unit (CPU), etc.), one or more memories 135, and/or internal or external network interfaces or communications devices 125 (e.g., modem, network cards, etc.)).

Management module 116, interface module 122, registration module 132, smart contracts 146, decentralized applications (dApps) 148, and blockchain related applications 160 may include one or more modules or units to perform the various functions of present invention embodiments described below. The various modules (e.g., management module 116, interface module 122, registration module 132, blockchain related applications 160, etc.) may be implemented by any combination of any quantity of software and/or hardware modules or units, and may reside within memory 135 of the server and/or client systems for execution by a corresponding processor 115. The various modules of the blockchain (e.g., smart contracts 146, decentralized applications (dApps) 148, etc.) may be implemented by any combination of any quantity of software and/or hardware modules or units, and may reside on a blockchain 142 for execution by one or more nodes 144.

An example of a computing device 200 for environment 100 (e.g., implementing server systems 110, client systems 114, registration systems 130, blockchain systems 140, nodes 144, etc.) is illustrated in FIG. 2. The example computing device may perform the functions of present invention embodiments described herein. Computing device 200 may be implemented by any personal or other type of computer or processing system (e.g., desktop, laptop, hand-held device, smartphone or other mobile device, etc.), and may be used for any computing environments (e.g., cloud computing, client-server, network computing, mainframe, stand-alone systems, etc.).

Computing device 200 may include one or more processors 115 (e.g., microprocessor, controller, central processing unit (CPU), etc.), network interface 125, memory 135, a bus 210, and an Input/Output interface 220. Bus 210 couples these components for communication, and may be of any type of bus structure, including a memory bus or memory controller, a peripheral bus, and a processor or local bus using any of a variety of conventional or other bus architectures. Memory 135 is coupled to bus 210 and typically includes computer readable media including volatile media (e.g., random access memory (RAM), cache memory, etc.), non-volatile media, removable media, and/or non-removable media. For example, memory 135 may include storage 250 containing non-removable, non-volatile magnetic or other media (e.g., a hard drive, etc.). The computing device may further include a magnetic disk drive and/or an optical disk drive (not shown) (e.g., CD-ROM, DVD-ROM or other optical media, etc.) connected to bus 210 via one or more data interfaces.

Moreover, memory 135 includes a set of program modules 215 (e.g., corresponding to management module 116, interface module 122, registration module 132, blockchain software (e.g., smart contracts 146, decentralized applications (dApp) 148, blockchain management software, etc.), blockchain related applications 160, network site or service software, etc.) that are configured to perform functions of present invention embodiments described herein. The memory may further include an operating system, at least one application and/or other modules, and corresponding data. These may provide an implementation of a networking environment.

Input/Output interface 220 is coupled to bus 210 and communicates with one or more peripheral or external devices 230 (e.g., a keyboard, mouse or other pointing device, a display, sensing devices, etc.), at least one device that enables a user to interact with computing device 200, and/or any device (e.g., network card, modem, etc.) that enables computing device 200 to communicate with one or more other computing devices. Computing device 200 may communicate with one or more networks (e.g., a local area network (LAN), a wide area network (WAN), a public network (e.g., the Internet), etc.) via network interface 125 coupled to bus 210.

With respect to certain entities (e.g., client system 114, etc.), computing device 200 may further include, or be coupled to, a touch screen or other display 225, a camera or other image capture device 235, a microphone or other sound sensing device 240, a speaker 245 to convey sound, and/or a keypad or keyboard 255 to enter information (e.g., alphanumeric information, etc.). These items may be coupled to bus 210 or Input/Output interface 220 to transfer data with other elements of computing device 200.

Initially, a blockchain (e.g., blockchain 142, etc.) is generally in the form of a ledger that includes a series of records or blocks chained or linked together. Each block includes a hash of the prior block in the blockchain, a timestamp, and transaction information. The hash of the prior block enables the blockchain to be resistant to modification since changes to data in any prior block alter the hash value which propagates to subsequent blocks.

A blockchain is typically managed by a peer-to-peer network and used as a distributed ledger. Nodes of the peer-to-peer network communicate and verify new blocks according to a protocol. The peer-to-peer network provides a decentralized approach, where each node has a copy of the blockchain. Transactions are transmitted to the network, where mining nodes process the transactions. The mining nodes validate a transaction, insert the transaction into a current block, and transmit the block to the other nodes. Various consensus approaches may be used for combining validation results of different mining nodes to determine validity of a transaction (or block).

Users of transactions for the blockchain are authenticated based on cryptographic keys. These keys identify a user and provide access to a user wallet. The user wallet is basically an application or software that enables users to store and access digital assets (e.g., for receiving or sending cryptocurrency or other fungible tokens, non-fungible tokens (NFTs), etc.). For example, a non-fungible token (NFT) is a crypto type asset with each token being unique (and representing items, such as digital art, music, or video game items), whereas fungible tokens (e.g., coins of the same cryptocurrency) have the same value of worth and are exchangeable. Each user is associated with their own private key (e.g., accessible only to the associated user, etc.) and a public key (e.g., typically an address on the blockchain). The private and public keys enable authentication of the user based on digital signatures in order to commence a transaction. The user wallet typically stores the private key.

For example, in order for the user to send cryptocurrency, a message for a transaction is encrypted (or signed) using the private key of the user wallet. The private key enables only the user to control the user wallet. A digital signature is created by encrypting the message with the private key, where the digital signature is used to verify the user and transaction. The message may be decrypted with the corresponding public key of the user wallet. Since the private key is unique to the user, successful decryption of the message with the corresponding public key verifies the message was sent by the user. Once verified, the transaction may be posted to the blockchain, thereby adjusting the user account based on the transaction.

In addition, a blockchain may store software (e.g., smart contracts 146) that executes in response to occurrence of pre-defined conditions. A smart contract is generally software or a program that runs on the blockchain. The code and data for the smart contract reside at a specific address on the blockchain. Non-fungible tokens (NFTs) are controlled by smart contracts that handle transference and verification of ownership of the non-fungible tokens (NFTs). A blockchain may be public (e.g., no access restrictions, etc.), private (e.g., restricted access, etc.), or hybrid (e.g., with centralized and decentralized features).

A blockchain domain name is stored on a blockchain. A blockchain domain name may be a non-fungible token (NFT) domain name that is associated with a non-fungible token (NFT) stored in a user wallet account. The blockchain domain name may be associated with various information (e.g., wallet addresses or accounts, user information (e.g., name, address, email, etc.), data or other access restrictions, etc.). The blockchain domain name is associated with software or smart contracts on the blockchain that may perform various functions (e.g., provide a registry for corresponding wallet addresses, indicate locations of content for the domain (e.g., or a website, etc.) hosted on the blockchain or other system, etc.). In order to access a blockchain domain, the blockchain is accessed to find the record corresponding to the blockchain domain name (which may initiate the corresponding smart contracts for the corresponding functionality). The private key of the user wallet enables the user to have sole control of the blockchain domain (e.g., authenticating operations or transactions for the blockchain domain name similar to the cryptocurrency example described above, etc.). For example, the user may have sole control to perform operations that alter content and/or functionality for the blockchain domain.

An embodiment of the present invention leverages options (e.g., conditions for transfer, such as loans, etc.) available for obtaining onchain assets (e.g., Web3 domains or domain names, blockchain domains or domain names, non-fungible tokens (NFTs), etc.) in order to acquire offchain assets (e.g., Web2 domains or domain names, ICANN domains or domain names, Domain Name System (DNS) domains or domain names, etc.). The present invention embodiment transfers the offchain asset (e.g., Web2 domain or domain name, ICANN domain or domain name, Domain Name System (DNS) domain or domain name, etc.) to a user based on satisfaction of transfer conditions for the corresponding onchain asset. For example, an offchain asset (e.g., Web2 domain or domain name, ICANN domain or domain name, Domain Name System (DNS) domain or domain name, etc.) may be obtained using a loan against a corresponding onchain asset (e.g., Web3 domain or domain name, blockchain domain or domain name, non-fungible token (NFT), etc.), thereby enabling loans to be used to acquire the offchain asset. Transfer of an onchain or offchain asset may include any action or transaction that provides ownership, rights, registration, and/or any other interest in the onchain or offchain asset. Further, acquiring or obtaining an onchain or offchain asset may include obtaining ownership, rights, registration, and/or any other interest in the onchain or offchain asset.

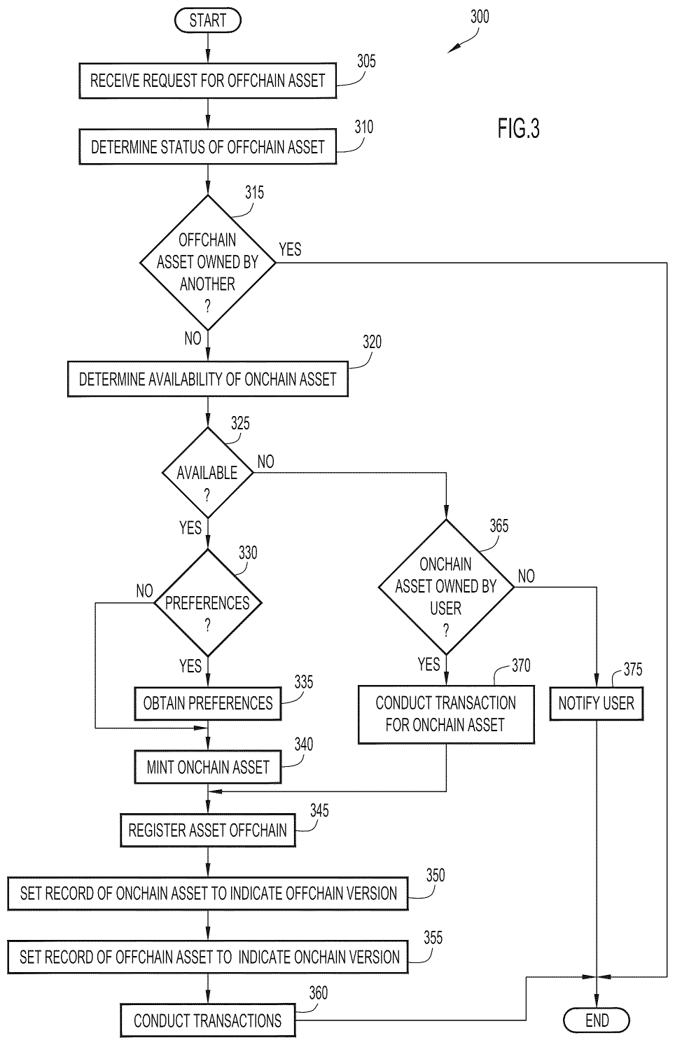

A method 300 of registering a name or other identifier for an onchain asset (e.g., Web3, blockchain, etc.) based on a name or other identifier for an offchain asset (e.g., Web2, Domain Name System (DNS), etc.) (e.g., via management module 116, registration module 132, smart contract 146, distributed application (dApp) 148, blockchain related application 160, server system 110, client system 114, registration system 130, and/or blockchain system 140) according to an embodiment of the present invention is illustrated in FIG. 3. This enables an offchain asset to be obtained by leveraging the options for acquiring an onchain asset. Initially, a user may register, or desire to register, a name or other identifier for an offchain asset (e.g., Web2, ICANN, Domain Name System (DNS), etc.) via management module 116 of server system 110. The user may further desire to register the name or other identifier of the offchain asset for an onchain asset (e.g., Web3, blockchain, non-fungible token (NFT), etc.) via management module 116 to leverage for the offchain asset the options available for acquiring the onchain asset. An asset may include any item or object associated with a computer or network environment (e.g., a domain, a domain name, a set of records, an object that points to a set of records, a non-fungible token (NFT), non-fungible token (NFT) domain names, a fungible token, a wallet address, email or other service, communication entity, etc.). An onchain asset may include any asset residing on, or supported by, a blockchain or other decentralized system (e.g., Web3 asset, asset of a decentralized system, asset of a partial or hybrid decentralized system, etc.). An offchain asset may include any asset residing on, or supported by, a centralized system or a system with centralized control (e.g., Web2, Domain Name System (DNS), system other than a decentralized system described above, etc.). The name or other identifier for the offchain and onchain assets may include a name portion and an optional extension (e.g., “name.e1”, etc.). Alternatively, the name or other identifier may include the name portion without the extension. The name portion and extension may each include any quantity of terms, words, tokens, or arrangements of any quantity of any types of elements (e.g., alphanumeric or other characters, symbols, numbers, etc.). A user may include, or be associated with, any type of entity (e.g., individual, company, organization, decentralized autonomous organization (DAO), etc.).

Management module 116 receives a request for the name or other identifier of the offchain asset at operation 305. The management module performs a look-up of the name of the offchain asset at operation 310 to determine registration/ownership of the offchain asset by another user (e.g., indicating unavailability of the offchain asset). By way of example, the offchain asset may include an offchain domain name (e.g., Web2, Domain Name System (DNS), etc.), and management module 116 requests information (e.g., DNS records, etc.) for the offchain domain name from registration system 130. The information from the registration system indicates registration/ownership or availability of the offchain asset.

When the offchain asset is not registered/owned by another user as determined at operation 315, management module 116 determines availability of the name of the offchain asset for an onchain asset at operation 320. In other words, management module determines availability of an onchain equivalent of the offchain asset. For example, the management module (e.g., via blockchain related application 160) accesses an intended blockchain 142 for the onchain version (e.g., via a blockchain system 140), and performs a look-up for the name of the offchain asset on the blockchain. Absence of a record on the blockchain for the name indicates the name for the offchain asset (or onchain version) is available on the blockchain. The intended blockchain may be selected by a user, and the name for the look-up may include the name portion of the name of the offchain asset (e.g., with the same extension, a corresponding extension for the intended blockchain, etc.).

When an onchain representation of the offchain asset is available as determined at operation 325, payment and other preferences may be provided or selected for acquiring (or minting) the onchain version. The options or preferences may include payment to acquire the onchain representation, an intended blockchain or other system to mint the onchain version, a smart contract for the transaction, etc. When preferences are required as determined at operation 330, management module 116 obtains the preferences at operation 335.

The preferences may be stored offchain in database system 118, or received from an administrator. By way of example, the preferences may enable the user to leverage for the offchain asset the options or preferences available for acquiring the onchain asset. For example, a loan for the onchain asset may be obtained in substantially the same manner described above to acquire the onchain asset (and offchain asset). Management module 116 may include, or have access to, a blockchain-based non-fungible token (NFT) loan system as described above to facilitate borrowing and lending using NFTs as collateral. Once the loan is repaid, ownership of the onchain asset is transferred to the user in substantially the same manner described below. In addition, repayment of the loan automatically enables transfer of the offchain asset to the user as described below.

The name for the onchain version is acquired at operation 340. For example, management module 116 (e.g., via blockchain related application 160, corresponding smart contract 146, and/or distributed application (dApp) 148) mints (or publishes) the name for the onchain version on a corresponding blockchain. The minting may be performed based on any required preferences. This may be accomplished by management module 116 (e.g., via blockchain related application 160, corresponding smart contract 146, and/or distributed application (dApp) 148) providing a transaction to the blockchain indicating ownership of the onchain version by the user (and/or lender or other entity associated with the transaction). In addition, various information for the onchain version (e.g., user information, asset information, wallet information, etc.) may be stored onchain and/or in offchain storage (e.g., database system 118, etc.).

The name for the offchain asset is registered offchain at operation 345. In this case, management module 116 (e.g., via registration module 132 of registration system 130) registers the name of the offchain asset to the user (and/or lender or other entity associated with the transaction) by indicating the ownership in records of the offchain asset. By way of example, registration module 132 creates a set of one or more (e.g., Domain Name System (DNS)) records containing ownership and other information when an offchain domain name is registered. For example, the records may include records of one or more record types including an address (or A) record, a hostname pointing (or canonical name (CNAME) alias) record, a mail (or MX) record, a name server (or NS) record, a private name server record, a start of authority (or SOA) record, a text (or TXT/SPF) record, and a service (or SRV) record.

In order to link the offchain and onchain versions, management module 116 (e.g., via distributed application (dApp) 148 and/or blockchain related application 160) sets a record associated with the onchain asset to indicate the offchain asset at operation 350. For example, an onchain or offchain record may be created or modified to include an identifier for the offchain asset (e.g., an offchain domain name to be linked, etc.).

In addition, management module 116 (e.g., via registration module 132 of registration system 130) sets a record associated with the offchain asset to indicate the onchain representation at operation 355. For example, a Domain Name System (DNS) canonical name or other record may be created or modified to include an identifier for the onchain asset (e.g., onchain domain name, wallet address, etc.).

Once the records linking the onchain and offchain representations are processed, transactions are conducted (e.g., via management module 116 and/or blockchain related application 160) at operation 360 using the names for the onchain or offchain assets. For example, the information in the record for the offchain asset may be used to resolve data for the onchain representation (e.g., a user may send cryptocurrency to an offchain asset (based on an associated record indicating the onchain asset), etc.). The transaction may be analyzed to determine the actions, underlying system, and the corresponding representation needed for that system. By way of example, when the transaction is for an onchain representation (or domain) for an onchain system using an offchain representation (or domain), a lookup of the Domain Name System (DNS) canonical name or other record associated with the offchain representation (e.g., Web2/offchain/DNS version of the onchain domain) is performed to obtain the onchain representation for conducting the transaction. A similar approach may be used for offchain transactions using onchain representations.

Further, transactions conducted for an onchain or offchain representation may automatically be applied to the linked (offchain or onchain) representation based on the linking information. By way of example, selling an offchain representation also sells the linked onchain representation (and vice versa), transferring the onchain representation also transfers the linked offchain representation (and vice versa), making available for auction the onchain representation also makes the linked offchain representation available (and vice versa), purchasing an offchain representation brand new also purchases the linked onchain representation (and vice versa), taking out a loan may apply to the linked representations or be conducted using one of the linked representations, extending expiration of (or renewing) an offchain representation extends (or renews) the registration for a linked onchain representation (and vice versa), and/or transferring an offchain domain to a new registrar (in the case of domains) transfers the onchain domain to the new registrar (or vice versa) or the transfer may be conducted using one of the linked representations.

When the onchain asset is not available, but already owned by the user requesting the offchain asset based on the look-up (e.g., an onchain representation of the offchain asset is already owned by the user requesting the offchain asset) as determined at operations 325, 365, a transaction for the onchain asset is conducted at operation 370. This enables the offchain asset to leverage options available for the onchain asset in order to acquire the offchain asset. By way of example, a loan may be obtained against the onchain asset (used as collateral) in substantially the same manner described above and used for payment of the offchain asset. Once the loan is repaid, the offchain asset is transferred to the user as described below. Management module 116 registers the name for the offchain asset at operation 345, links the onchain and offchain assets at operations 350, 355, and conducts transactions at operation 360 in substantially the same manner described above.

When the onchain asset is not available and owned by another user based on the look-up (e.g., an onchain representation of the offchain asset is already owned by another user) as determined at operations 325, 365, management module 116 alerts or notifies the user at operation 375. The notification may indicate ownership information for the onchain version of the offchain asset.

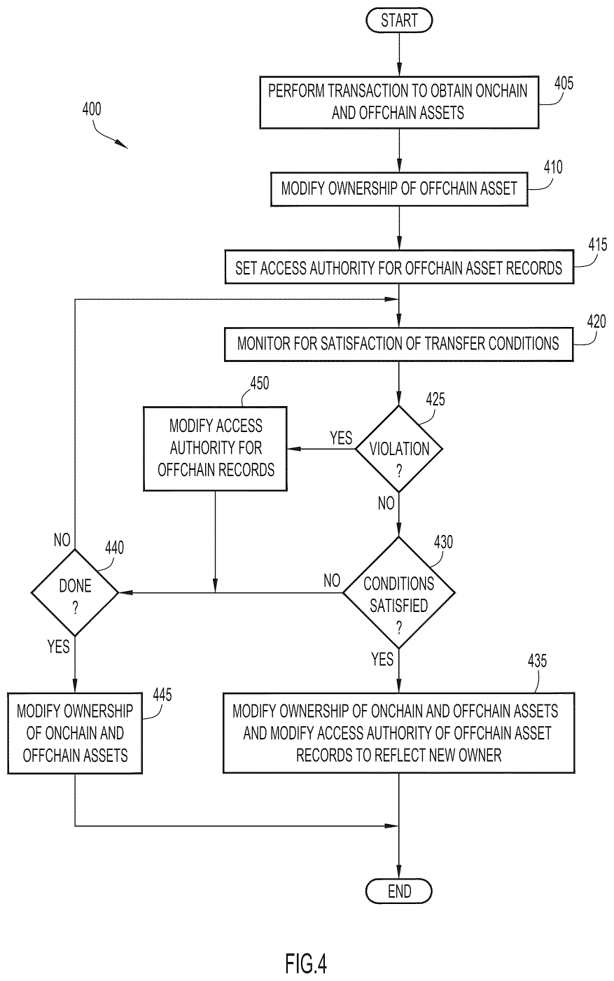

A method 400 of transferring an offchain asset based on satisfying transfer conditions for an onchain asset (e.g., via management module 116, registration module 132, smart contract 146, decentralized application (dApp) 148, blockchain related application 160, server system 110, client system 114, registration system 130, and/or blockchain system 140) according to an embodiment of the present invention is illustrated in FIG. 4. Initially, management module 116 performs a transaction to obtain an offchain asset (e.g., Web2 domain or domain name, ICANN domain or domain name, Domain Name System (DNS) domain or domain name, etc.) and an onchain asset (e.g., Web3 domain or domain name, blockchain domain or domain name, non-fungible token (NFT), etc.) for a user at operation 405 in substantially the same manner described above (FIG. 3). The user may include, or be associated with, any type of entity (e.g., individual, company, organization, decentralized autonomous organization (DAO), etc.). Transfer of an onchain or offchain asset may include any action or transaction that provides ownership, rights, registration, and/or any other interest in the onchain or offchain asset. Further, acquiring or obtaining an onchain or offchain asset may include obtaining ownership, rights, registration, and/or any other interest in the onchain or offchain asset.

By way of example, method 400 is described with respect to an onchain asset including a Web3 or blockchain domain or domain name (e.g., represented by a non-fungible token (NFT)) and an offchain asset including a Web2, ICANN, or Domain Name Service (DNS) domain or domain name, and a loan used for obtaining the onchain asset (and corresponding offchain asset). However, any onchain and offchain assets may be transferred using any conditions for transfer in substantially the same manner described below. The transaction results in a partial interest of the onchain asset by the user (e.g., partial interest by the user, a seller or prior owner, and/or a lender or other entity assisting (or having an interest) in the acquisition of the onchain and offchain assets).

By way of example, a loan may be obtained for the onchain asset (e.g., blockchain domain or domain name, etc.) in substantially the same manner described above. The loan may be provided from the seller of the onchain asset (e.g., non-fungible token (NFT), etc.) or other entity, such as a registrar or marketplace provider. The loan may be a peer to peer loan or a business to consumer loan. With respect to a peer to peer loan, an owner or other interest holder of the onchain asset receives payments over time until the loan is paid off. The loan may or may not include interest. A business to consumer loan is typically provided by a financial or lending institution or organization.

Further, the transaction for the onchain asset may provide a fractional interest in the onchain asset for the user. For example, the user may be an additional owner (besides the seller or original owner) that obtains a portion of ownership of the onchain asset. Fractional interest may be represented by non-fungible tokens (NFTs) each indicating the percentage of interest (or ownership) of a corresponding owner or user. These NFTs are stored in corresponding wallet accounts of the user and one or more other entities associated with the transaction (e.g., current owner/seller, lender, etc.). A user owns the onchain asset when the user obtains all of the fractional portions for that onchain asset. An NFT may be added to the user wallet (and wallet of the other entities associated with the transaction) for each payment received from the user and indicating a new interest portion. The payments are preferably in cryptocurrency and remitted on the blockchain, but may be of any currency. The payments may be from any entity associated with the user (e.g., a decentralized autonomous organization (DAO) using voting to authorize performance of actions, etc.).

Smart contract 146 may monitor for payments, provide the NFTs for updated interest, and detect satisfaction of the loan. For example, when terms of a loan include ten payments, each payment effectively transfers an additional ten percent interest to the user (and removes ten percent interest from the other entities associated with the transaction (e.g., seller or original owner, lender, etc.)). This may be represented by minting (or publishing) new NFTs on the blockchain for each payment indicating the updated interest for the user and other entities associated with the transaction.

Management module 116 (e.g., via registration module 132 and registration system 130) modifies an ownership record of the offchain asset at operation 410. For example, Domain Name System (DNS) records for the offchain asset or domain may be modified to indicate a new interest or ownership. By way of example, the ownership of the offchain asset may be set to the entity (e.g., user, company, etc.) that holds a majority interest or ownership of the onchain asset (e.g., the onchain asset or non-fungible token (NFT) associated with the loan may reflect the interest, etc.). With respect to a business to consumer loan, the lender providing the loan for the onchain asset or domain may be indicated as the owner. In addition, the ownership may indicate each entity with a fractional interest or ownership (e.g., user, company, lender, seller, prior owner, etc.), and optionally the percentage of interest or ownership.

Management module 116 (e.g., via registration module 132 and registration system 130) sets access authority for the records of the offchain asset at operation 415. The offchain asset records may include Domain Name System (DNS) records, nameserver records, mailserver records, etc. Access to the offchain asset records is preferably provided to the user. This enables the user to manage, host, or start using the offchain asset or domain after completing the transaction for the onchain asset and during payment of the loan (e.g., by indicating servers, IP addresses, etc. associated with the user in the DNS records).

Further, access to the records of the offchain asset may be provided to other entities associated with the transaction (e.g., seller or original owner of the onchain asset, lender, etc.) until an agreed upon time. By way of example, the time may be when a majority of the interest or ownership of the onchain asset is held by the user, the loan is paid off in full, or full ownership or interest of the onchain asset is obtained by the user.

Moreover, the user and one or more other entities associated with the transaction (e.g., seller or original owner of the onchain asset, lender, etc.) may be provided access to the records of the offchain asset until the loan is paid in full (e.g., at which point access to the offchain asset records for the other associated entities is removed, etc.). In addition, access to the offchain asset records may be based on a percentage of interest or ownership (e.g., access (or certain rights) are provided or removed from owners based on some threshold percentage of interest or ownership of the onchain asset, such as 25%, 50%, etc., user or entity with a greatest percentage of interest or ownership of the onchain asset receives access, etc.).

Once the ownership and access are assigned for the offchain asset, smart contract 146 monitors for occurrence of conditions for transfer of the onchain asset at operation 420. By way of example, smart contract 146 may monitor transactions (or payments) in accordance with terms of the loan. The payments are preferably in cryptocurrency and remitted on the blockchain, but may be of any currency. The payments may be from any entity associated with the user (e.g., a decentralized autonomous organization (DAO) using voting to authorize performance of actions, etc.). An NFT may be added to the user wallet (and wallet associated with one or more other entities associated with the transaction) for each payment received from the user and indicating a new interest or ownership portion. For example, when terms of a loan include ten payments, each payment effectively transfers an additional ten percent interest to the user (and removes ten percent interest from the other entities associated with the transaction (e.g., seller or original owner, lender, etc.)). This may be represented by minting (or publishing) new NFTs on the blockchain for each payment indicating the updated interest for the user and other entities associated with the transaction. Smart contract 146 monitors for the payments, provides the NFTs for updated interest or ownership, and detects satisfaction of the loan.

Smart contract 146 may further detect violations of the conditions of transfer. For example, a violation may include failure to satisfy loan terms provided by the smart contract (e.g., late payment, no payment, etc.), and/or abuse of the onchain and/or offchain asset (e.g., a takedown request has been received for an onchain and/or offchain domain for suspicious or malicious activity, etc.). The smart contract may provide an indication of a payment and/or violation, or may be periodically accessed by management module 116 (e.g., via blockchain related application 160) to ascertain the presence or absence of a payment and/or violation from the smart contract.

When no violation has been detected as determined at operation 425, smart contract 146 may determine occurrence of conditions for transfer of the onchain asset. The conditions may include the loan being repaid, and/or the user obtaining full interest or ownership (e.g., based on the non-fungible tokens (NFTs) received for payments). For example, the smart contract may track payments against the loan terms (e.g., number of payments, total payment amount, etc.) and determine when the loan has been repaid. Further, the smart contract may access the blockchain (and user wallet account) to determine when the user has attained full interest or ownership (based on NFTs associated with payment and indicating the interest or ownership percentage). The smart contract may provide an indication of full payment of the loan or full interest or ownership of the onchain asset by the user, or may be periodically accessed by management module 116 (e.g., via blockchain related application 160) to ascertain the loan and/or interest or ownership status from the smart contract.

When the conditions for transfer are satisfied as determined at operation 430, management module 116 (e.g., via registration module 132, smart contract 146, distributed application (dApp) 148, and/or blockchain related application 160) modifies ownership of the onchain asset and offchain asset at operation 435 to indicate the user as the owner. By way of example, management module 116 (e.g., via blockchain related application 160, corresponding smart contract 146, and/or distributed application (dApp) 148) provides a transaction to the blockchain indicating ownership of the onchain asset by the user.

By way of further example, registration module 132 may modify one or more (e.g., Domain Name System (DNS)) records containing ownership and other information to indicate transfer of the offchain asset to the user as the new owner when the transfer conditions for the onchain asset are satisfied. Transfer of ownership of the offchain asset may include updating a public database of offchain asset or domain information (e.g., WhoIs, etc.).

Further, management module 116 (e.g., via registration module 132 and registration system 130) modifies the access authority at operation 435 to enable the user to access the records of the offchain asset (e.g., and remove access to the offchain asset records for the other entities associated with the transaction (e.g., lender, prior owner, fractional owners, etc.)). By way of example, registration module 132 may modify one or more (e.g., Domain Name System (DNS)) records containing access and other information to enable the user to access the offchain asset records and remove access to the other entities when the transfer conditions for the onchain asset are satisfied.

When a violation is detected at operation 425, management module 116 (e.g., via registration module 132 and registration system 130) modifies the access authority for the records of the offchain asset at operation 450. For example, the violation may include violation of loan terms provided by the smart contract (e.g., late payment, no payment, etc.), and/or abuse of the onchain and/or offchain asset (e.g., a takedown request has been received for an onchain and/or offchain domain for suspicious or malicious activity, etc.). The access authority may be modified to remove access to the offchain asset records by the user and/or add access for one or more other entities associated with the transaction (e.g., seller or original owner, lender, etc.). By way of example, registration module 132 may modify one or more (e.g., Domain Name System (DNS)) records containing access and other information to remove access for the user and/or add access for the other entities.

Once the access authority is modified, the above process may be repeated from operation 420 to monitor conditions in substantially the same manner described above when the transaction remains viable as determined at operation 440. The conditions are monitored until the transfer conditions are satisfied as determined at operation 430, or the transaction for the onchain asset is terminated as determined at operation 440. For example, the smart contract may determine, or monitor the blockchain for transactions that indicate, that the loan has been canceled or terminated. The termination of the loan may be at the discretion of the lender and/or borrower, due to reduction of the value of the onchain asset, and/or repeated or critical violations of terms of the loan. The smart contract may provide an indication of termination of the loan, or may be periodically accessed by management module 116 (e.g., via blockchain related application 160) to ascertain the loan status from the smart contract.

Once the transaction for the onchain asset is terminated, the ownership of the onchain and offchain assets are modified to transfer the onchain and offchain assets to one or more appropriate other entities associated with the transaction (e.g., seller or original owner, lender, etc.) at operation 445 in substantially the same manner described above. By way of example, management module 116 (e.g., via blockchain related application 160, corresponding smart contract 146, and/or distributed application (dApp) 148) provides a transaction to the blockchain indicating ownership of the onchain asset by the appropriate other entities. By way of further example, registration module 132 may modify one or more (e.g., Domain Name System (DNS)) records containing ownership and other information to indicate transfer of the offchain asset to the appropriate other entities.

Further, the access authority may be modified to remove access to the records of the offchain asset by the user and/or add access for one or more appropriate other entities associated with the transaction (e.g., seller or original owner, lender, etc.). By way of example, registration module 132 may modify one or more (e.g., Domain Name System (DNS)) records containing access and other information to remove access for the user and/or add access for the appropriate other entities.

For example, when a seller or owner provides the loan, the ownership and access may be transferred back to the seller or owner. Further, when a lending institution or other lender provides the loan with the onchain asset as collateral, the ownership and access may be transferred to the lender.

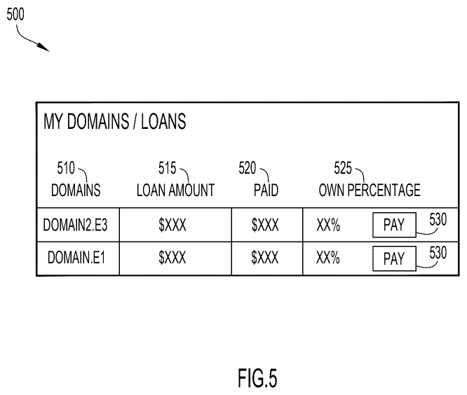

An example graphical user interface 500 providing registered blockchain domain names of a user with corresponding loan information according to an embodiment of the present invention is illustrated in FIG. 5. Initially, a user may obtain an offchain asset based on a transaction for a corresponding onchain asset in substantially the same manner described above. By way of example, the offchain asset may include a centralized domain name (e.g., Web2 domain name, ICANN domain name, Domain Name System (DNS) domain name, etc.) and the corresponding onchain asset may include a blockchain domain name. A loan may be obtained to acquire the blockchain domain name in substantially the same manner described above. Management module 116 may perform a look-up (e.g., via blockchain system 140) in substantially the same manner described above to identify the registered blockchain domain names of the user and corresponding loan information (e.g., amounts, payments, etc.).

The management module provides the identified blockchain domain names and loan information on user interface 500. The user interface includes a table with rows for each blockchain domain name, and columns or fields including a domain field 510 for the blockchain domain name, a loan amount field 515 indicating the loan amount, a paid field 520 indicating a total of payments made, and an ownership field 525 indicating an ownership percentage of the blockchain domain (and corresponding centralized domain name) (e.g., the amount paid divided by the loan amount). Accordingly, a user may view their blockchain domains (and associated centralized domains) and corresponding loan status. In addition, the user interface may further include a payment actuator 530 for each blockchain domain name to initiate a payment for a corresponding loan.

Operation of an embodiment of the present invention for an example scenario is described. By way of example, a user cannot afford to obtain a desired offchain domain. However, a domain marketplace provides an option to obtain a loan for the domain for a reasonable monthly amount. This is a much more affordable option for the user. The offchain domain is tokenized (e.g., a corresponding onchain domain (represented by a non-fungible token (NFT)) is obtained in substantially the same manner described above) to create a blockchain record allowing for the loan payment to occur on the blockchain. This enables the user to immediately start managing or hosting a website at the offchain domain according to the terms of the loan. Each month the user remits payment until eventually the user owns the tokenized (or non-fungible token (NFT)) version of the domain outright. At that time, the present invention embodiment recognizes that the loan has been paid and modifies ownership of the onchain version. This triggers modification of the corresponding offchain (or Domain Name System (DNS)) records to reflect that the user is now the owner.

Present invention embodiments may provide various technical and other advantages. For example, present invention embodiments provide enhanced manners of accessing an asset, and enable use of asset identifiers (and access of corresponding assets) across different networks (e.g., DNS and blockchain, etc.). Present invention embodiments enable transactions using any of the corresponding offchain and onchain identifiers or domain names, thereby providing new functionality to an identifier of a network that is absent on that network (e.g., send cryptocurrency to a centralized or Web2 domain name, etc.). Further, the blockchain is continuously monitored in real-time for occurrence of the transfer conditions for the onchain asset which automatically triggers the transfer of the offchain asset. This provides new functionality for the offchain asset and enables options available only for onchain assets to be used for offchain assets. Conditions for several blockchain assets may be monitored concurrently to initiate transfers of offchain assets based on satisfaction of the transfer conditions.

It will be appreciated that the embodiments described above and illustrated in the drawings represent only a few of the many ways of implementing embodiments for transfer of an offchain asset based on satisfaction of transfer conditions for an onchain asset. In addition, characteristics or features of embodiments of the present invention may be combined in any fashion to provide additional embodiments of the present invention.

The environment of the present invention embodiments may include any number of computer or other processing systems (e.g., client or end-user systems, server systems, blockchain systems, etc.) and databases or other repositories arranged in any desired fashion, where the present invention embodiments may be applied to any desired type of computing environment (e.g., cloud computing, client-server, network computing, mainframe, stand-alone systems, etc.). The computer or other processing systems employed by the present invention embodiments may be implemented by any number of any personal or other type of computer or processing system (e.g., desktop, laptop, hand-held devices, smartphones or other mobile devices, etc.), and may include any commercially available operating system and any combination of commercially available and custom software (e.g., communications software; server software; software of present invention embodiments (including management module 116, interface module 122, registration module 132, smart contracts 146, decentralized applications (dApps) 148, blockchain related applications 160, etc.); etc.). These systems may include any types of monitors and input devices (e.g., keyboard, mouse, voice recognition, etc.) to enter and/or view information.

It is to be understood that the software of the present invention embodiments (e.g., management module 116, interface module 122, registration module 132, smart contracts 146, decentralized applications (dApps) 148, blockchain related applications 160, etc.) may be implemented in any desired computer language and could be developed by one of ordinary skill in the computer arts based on the functional descriptions contained in the specification and flowcharts illustrated in the drawings. Further, any references herein of software performing various functions generally refer to computer systems or processors performing those functions under software control. The computer systems of the present invention embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present invention embodiments may be distributed in any manner among the various end-user/client, server, registration, and blockchain systems, and/or any other intermediary processing devices. The software and/or algorithms described above and illustrated in the flowcharts may be modified in any manner that accomplishes the functions described herein. In addition, the functions in the flowcharts or description may be performed in any order that accomplishes a desired operation.

The software of the present invention embodiments (e.g., management module 116, interface module 122, registration module 132, smart contracts 146, decentralized applications (dApps) 148, blockchain related applications 160, etc.) may be available on a non-transitory computer useable or readable medium (e.g., magnetic or optical mediums, magneto-optic mediums, CD-ROM, DVD, memory devices, etc.) of a stationary or portable computer program product, apparatus, or device for use with stand-alone systems or systems connected by a network or other communications medium. The computer usable or readable medium (or media) may include instructions executable by one or more processors to perform functions of present invention embodiments described herein.

The communication network may be implemented by any number of any type of communications network (e.g., LAN, WAN, Internet, Intranet, VPN, etc.). The computer or other processing systems of the present invention embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

The system may employ any number of any conventional or other databases, data stores or storage structures (e.g., files, databases, data structures, data or other repositories, etc.) to store information (e.g., blockchain asset information, metadata, mappings of blockchain assets to blockchains, loan information, preferences, etc.). The database system may be implemented by any conventional or other databases, data stores or storage structures to store information. The database system may be included within or coupled to the server, client, registration, and/or blockchain systems. The database systems and/or storage structures may be remote from or local to the computer or other processing systems, and may store any desired data.

The present invention embodiments may employ any number of any type of user interface (e.g., Graphical User Interface (GUI), command-line, prompt, etc.) for obtaining or providing information (e.g., preferences, results of registration, notifications, domain or web site content, blockchain asset information, loan information, etc.), where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

The report may include any information arranged in any fashion, and may be configurable based on rules or other criteria to provide desired information to a user (e.g., blockchain assets, loan status and/or information, registrations, preferences, etc.).

The present invention embodiments are not limited to the specific tasks or algorithms described above, but may be utilized for automatically transferring offchain assets based on satisfaction of any conditions for transfer of corresponding onchain assets.

An asset may include any item or object associated with a computer or network environment (e.g., a domain, a domain name, a set of records, an object that points to a set of records, a non-fungible token (NFT), non-fungible token (NFT) domain names, a fungible token, a wallet address, email or other service, communication entity, etc.). An onchain asset may include any asset residing on, or supported by, a blockchain or other decentralized system (e.g., Web3 asset, asset of a decentralized system, asset of a partial or hybrid decentralized system, etc.). An offchain asset may include any asset residing on, or supported by, a centralized system or a system with centralized control (e.g., Web2, Domain Name System (DNS), ICANN accredited domain names, system other than a decentralized system described above, etc.). An onchain system may include any blockchain or other decentralized system (e.g., Web3, decentralized system, partial or hybrid decentralized system, etc.), while an offchain system may include any centralized system or system with centralized control (e.g., Web2, Domain Name System (DNS), system other than a decentralized system described above, etc.).

The name or other identifier for the offchain and onchain assets may include a name portion and an optional extension (e.g., “name.e1”, etc.). Alternatively, the name or other identifier may include the name portion without the extension. The name portion and extension may each include any quantity of terms, words, tokens, or arrangements of any quantity of any types of elements (e.g., alphanumeric or other characters, symbols, numbers, etc.).

Any quantity of any parameters, values, or other information may be associated with an asset. The information for an-off chain asset may include any information arranged in any fashion (e.g., values for domain records, domain parameters, server names or addresses, etc.). Any information of an offchain asset may be stored for an onchain asset to link the assets. This information may be stored on a blockchain and/or on an offchain data source in any storage item (e.g., record, data object, etc.). The information for an onchain asset may include any information arranged in any fashion (e.g., values for asset attributes, blockchain, wallet address, user/owner information etc.). Any information of an onchain asset may be stored for an offchain asset to link the assets. This information may be stored on a blockchain and/or on an offchain data source in any storage item (e.g., record, data object, etc.). The offchain data source may include any storage structure (e.g., decentralized storage structure or platform, blockchain storage, database, etc.). The asset information may be stored and retrieved based on any information (e.g., based on registered user information (e.g., wallet address, blockchain asset, blockchain domain or user name, user information, etc.).

The onchain assets may be from any desired blockchains. Availability for an onchain asset may be determined by searching any onchain and/or offchain storage for any corresponding records or information indicating existence of the onchain asset on a system. Further, availability for an offchain asset may be determined by searching any onchain and/or offchain storage for any corresponding records or information indicating existence of the offchain asset on a system.

A name of an asset of a system may be used to access any corresponding assets of any other systems. For example, the information for the asset may indicate the information (e.g., names or identifiers, addresses, etc.) of the corresponding assets. The information may be retrieved based on the name of the asset and used to resolve the name of the asset to the location (e.g., system, name, address, etc.) of the corresponding assets on the other systems to access (and/or perform transactions) with respect to those corresponding assets. By way of example, a user may send cryptocurrency (e.g., a loan or other payment) to a Web2 domain name.

A user may include, or be associated with, any type of entity (e.g., individual, company, organization, decentralized autonomous organization (DAO), etc.). Transfer of an onchain or offchain asset may include any action or transaction that provides ownership, rights, registration, and/or any other interest in the onchain or offchain asset. Further, an interest may include ownership, rights, registration, and/or any other stake or share in the onchain or offchain asset. Moreover, acquiring or obtaining an onchain or offchain asset may include obtaining ownership, rights, registration, and/or any other interest in the onchain or offchain asset.

The onchain asset (and offchain asset) may be obtained via any type of transaction (e.g., loan, transfer of an item in exchange for the onchain asset, performance of an activity or service, payments/installments over time, etc.) with any types of terms or conditions (e.g., payment schedule, interest, amounts, activities to maintain or cancel the transaction, etc.). The conditions may include any quantity of any events or conditions for triggering transfer of the onchain and/or offchain assets (e.g., payment of a loan, transfer of an item in exchange for the onchain asset, performance of an activity or service, etc.). Any type of payment or currency may be used for obtaining the onchain asset (and corresponding offchain asset) (e.g., cryptocurrency, fiat currency or cash, etc.), and may be remitted in any fashion (e.g., onchain or blockchain transaction, offchain transaction, a combination of onchain and offchain transaction, etc.).

A violation may include any activity causing a breach of a term of the transaction. For example, a violation may include failure to satisfy loan terms provided by the smart contract (e.g., late payment, no payment, etc.), and/or abuse of the onchain and/or offchain asset (e.g., a takedown request has been received for an onchain and/or offchain domain for suspicious or malicious activity, etc.). Further, the violation may be critical to terminate or cancel the transaction, or may be corrected and enable the transaction to continue. The transaction may be terminated based on any desired activity. By way of example, the transaction may be terminated at the discretion of the entities involved in the transaction, due to reduction of the value of the onchain asset, and/or repeated or critical violations of terms of the transaction (or loan).

The transfer of the onchain asset may be accomplished via any blockchain or other transaction. For example, a transfer may be accomplished by conducting a transaction on the blockchain to indicate transfer of the onchain asset to a new owner. Further, transfer of the offchain asset may be accomplished by modifying any corresponding records of the offchain asset (e.g., Domain Name System (DNS) records, etc.). Moreover, access to the records of the offchain asset may be accomplished by modifying any corresponding records of the offchain asset (e.g., Domain Name System (DNS) records, etc.), and may be performed in response to satisfaction of any amount of conditions (e.g., acquiring a threshold amount of interest, tendering a threshold amount of payments, etc.).

Having described preferred embodiments of a new and improved system, method, and computer program product for transfer of an offchain asset based on satisfaction of transfer conditions for an onchain asset, it is believed that other modifications, variations and changes will be suggested to those skilled in the art in view of the teachings set forth herein. It is therefore to be understood that all such variations, modifications and changes are believed to fall within the scope of present invention embodiments as defined by the appended claims.

What is claimed is:

1. A method of transferring an offchain asset comprising:
receiving, via at least one processor, a request to obtain the offchain asset for a user;
conducting, via the at least one processor, a transaction for an onchain asset associated with the user and corresponding to the offchain asset;
monitoring, via the at least one processor, for a set of conditions associated with the transaction for the onchain asset; and
transferring, via the at least one processor, the offchain asset to the user in response to occurrence of the set of conditions.

2. The method of claim 1, wherein the onchain asset includes one from a group of a blockchain domain name and a non-fungible token, and the offchain asset includes a centralized domain name.

3. The method of claim 1, wherein the set of conditions includes repayment of a loan against the onchain asset.

4. The method of claim 1, wherein transferring the offchain asset comprises:
modifying one or more records of the offchain asset to indicate transfer of the offchain asset to the user.

5. The method of claim 1, further comprising:
modifying, via the at least one processor, one or more records of the offchain asset after performance of the transaction and prior to occurrence of the set of conditions to enable access to the one or more records by the user for managing the offchain asset.

6. The method of claim 5, further comprising:
modifying, via the at least one processor, one or more records of the offchain asset to remove access from the user in response to a violation of the transaction for the onchain asset.

7. The method of claim 1, further comprising:
modifying, via the at least one processor, one or more records of the offchain asset to enable access to the user and one or more entities of the transaction for the onchain asset.

8. The method of claim 1, further comprising:
modifying, via the at least one processor, one or more records of the offchain asset to enable access to the one or more records by the user for managing the offchain asset in response to satisfaction of a threshold amount of the set of conditions.

9. A system for transferring an offchain asset comprising:
one or more memories; and
at least one processor coupled to the one or more memories, the at least one processor configured to:
receive a request to obtain the offchain asset for a user;
conduct a transaction for an onchain asset associated with the user and corresponding to the offchain asset;
monitor for a set of conditions associated with the transaction for the onchain asset; and
transfer the offchain asset to the user in response to occurrence of the set of conditions.

10. The system of claim 9, wherein the onchain asset includes one from a group of a blockchain domain name and a non-fungible token, and the offchain asset includes a centralized domain name.

11. The system of claim 9, wherein the set of conditions includes repayment of a loan against the onchain asset.

12. The system of claim 9, wherein transferring the offchain asset comprises:
modifying one or more records of the offchain asset to indicate transfer of the offchain asset to the user.

13. The system of claim 9, wherein the at least one processor is further configured to:
modify one or more records of the offchain asset after performance of the transaction and prior to occurrence of the set of conditions to enable access to the one or more records by the user for managing the offchain asset.

14. The system of claim 13, wherein the at least one processor is further configured to:
modify one or more records of the offchain asset to remove access from the user in response to a violation of the transaction for the onchain asset.

15. The system of claim 9, wherein the at least one processor is further configured to:
modify one or more records of the offchain asset to enable access to the user and one or more entities of the transaction for the onchain asset.

16. The system of claim 9, wherein the at least one processor is further configured to:
modify one or more records of the offchain asset to enable access to the one or more records by the user for managing the offchain asset in response to satisfaction of a threshold amount of the set of conditions.

17. A computer program product for transferring an offchain asset, the computer program product comprising one or more non-transitory computer readable media having instructions stored thereon, the instructions executable by at least one processor to cause the at least one processor to:
receive a request to obtain the offchain asset for a user;
conduct a transaction for an onchain asset associated with the user and corresponding to the offchain asset;
monitor for a set of conditions associated with the transaction for the onchain asset; and
transfer the offchain asset to the user in response to occurrence of the set of conditions.

18. The computer program product of claim 17, wherein the onchain asset includes one from a group of a blockchain domain name and a non-fungible token, and the offchain asset includes a centralized domain name.

19. The computer program product of claim 17, wherein the set of conditions includes repayment of a loan against the onchain asset.

20. The computer program product of claim 17, wherein transferring the offchain asset comprises:
modifying one or more records of the offchain asset to indicate transfer of the offchain asset to the user.

21. The computer program product of claim 17, wherein the instructions further cause the at least one processor to:
modify one or more records of the offchain asset after performance of the transaction and prior to occurrence of the set of conditions to enable access to the one or more records by the user for managing the offchain asset.

22. The computer program product of claim 21, wherein the instructions further cause the at least one processor to:
modify one or more records of the offchain asset to remove access from the user in response to a violation of the transaction for the onchain asset.

23. The computer program product of claim 17, wherein the instructions further cause the at least one processor to:
modify one or more records of the offchain asset to enable access to the user and one or more entities of the transaction for the onchain asset.

24. The computer program product of claim 17, wherein the instructions further cause the at least one processor to:
modify one or more records of the offchain asset to enable access to the one or more records by the user for managing the offchain asset in response to satisfaction of a threshold amount of the set of conditions.
